(19) United States
(12) Patent Application Publication
(10) Pub. No.: US 2005/0072006 A1
(43) Pub. Date: Apr. 7, 2005

(54) Finishing tool

(76) Inventors: Mel Lee, Alsip, IL (US); Robert Muhn, Ft. Wayne, IN (US)

Correspondence Address: BEEM PATENT LAW FIRM, 53 W. JACKSON BLVD., SUITE 1352, CHICAGO, IL, 60604-3787, US

(21) Appl. No.: 10/678,907

(22) Filed: Oct. 3, 2003

(51) Int. Cl. B26B 3/00

(52) U.S. Cl. 30/169; 30/329; 30/344

(57) ABSTRACT

A novel finishing tool includes a substantially planar, generally rectangular stiff blade having an axis, a straight front edge substantially normal to the axis, and a rear, an elongate handle having a front and an axis, an adapter connected to the front of the handle, wherein the adapter has sides and at least a portion of each side tapers upwardly, a bracket having first and second legs, wherein the first leg is generally parallel to the blade and connected to the rear of the blade and the first leg has a rear, wherein the second leg extends upwardly from the rear of the first leg and the second leg has sides and at least a portion of each side tapers upwardly and the second leg is connected to the adapter, wherein the front of the handle is attached to the adapter so that the handle axis is generally parallel to the blade axis and generally centered with respect to the blade, wherein each side of the adapter forms a generally continuous taper with respect to a corresponding side of the second leg.

### BACKGROUND OF THE INVENTION

1. Field of the Invention

The present invention is directed to a finishing tool for drywall or plaster and particularly to a taping knife for use with drywall.

2. Description of the Related Art

Finishing tools for drywall or plaster, sometimes known as taping or finishing knives, are used for applying joint compound to drywall joints and plastering. Examples of drywall finishing tools are disclosed in U.S. Pat. Nos. 4,620,369; 4,217,673; and 6,006,384.

Prior art knives have had handles which are generally in line with a blade or knife. This design may cause the user to drag his or her hand in the joint compound as it is being applied. A drywall knife sold by M.R. Lee Building Materials had a generally rectangular stiff blade and a handle offset above the blade. However, the prior art knife had a rectangular adapter plate with right angle corners which were at the same time awkward in use and unsightly in appearance. In addition, the prior art knife was bulky and rapidly fatigued users. The prior art knife also used machine screws to attach the blade to the handle bracket. The machine screws were susceptible to snagging of drywall material, caking of compound, and distortion of the blade into a wavy surface.

What is needed is a finishing tool that is less awkward to use and less susceptible to snagging and caking of drywall material.

### BRIEF DESCRIPTION OF THE SEVERAL VIEWS OF THE DRAWINGS

FIG. 1 is a perspective view of a finishing tool in accordance with the invention.

FIG. 2 is a top view of the finishing tool.

FIG. 3 is a top view of the disassembled finishing tool.

FIG. 4 is a rear view of the finishing tool.

FIG. 5 is a bottom view of the finishing tool.

FIG. 6 is a front view of the finishing tool.

### BRIEF SUMMARY OF INVENTION

In accordance with the invention, a novel finishing tool includes a substantially planar, generally rectangular stiff blade having an axis, a straight front edge substantially normal to the axis, and a rear, an elongate handle having a front and an axis, an adapter connected to the front of the handle, wherein the adapter has sides and at least a portion of each side tapers upwardly, and a bracket having first and second legs. The first leg is generally parallel to the blade and connected to the rear of the blade and the first leg has a rear. The second leg extends upwardly from the rear of the first leg and the second leg has sides and at least a portion of each side tapers upwardly and the second leg is connected to the adapter. The front of the handle is attached to the adapter so that the handle axis is generally parallel to the blade axis and generally centered with respect to the blade. Each side of the adapter forms a generally continuous taper with respect to a corresponding side of the second leg.

In one aspect of the invention, the generally continuous taper formed between each side of the adapter and the corresponding side of the second leg is a generally straight line. In another aspect of the invention, the first leg of the finishing tool is connected to the rear of the blade by a plurality of rivets.

In still another aspect of the invention, a novel finishing tool includes a substantially planar, generally rectangular stiff blade having an axis, a straight front edge substantially normal to the axis, and a rear. An elongate handle has a front and an axis. Apparatus is provided for connecting the front of the handle to the rear of the blade so that the handle axis is above and generally parallel to the blade axis and generally centered with respect to the blade, wherein the connecting means has a profile with a generally continuous upward taper.

### DETAILED DESCRIPTION OF THE INVENTION

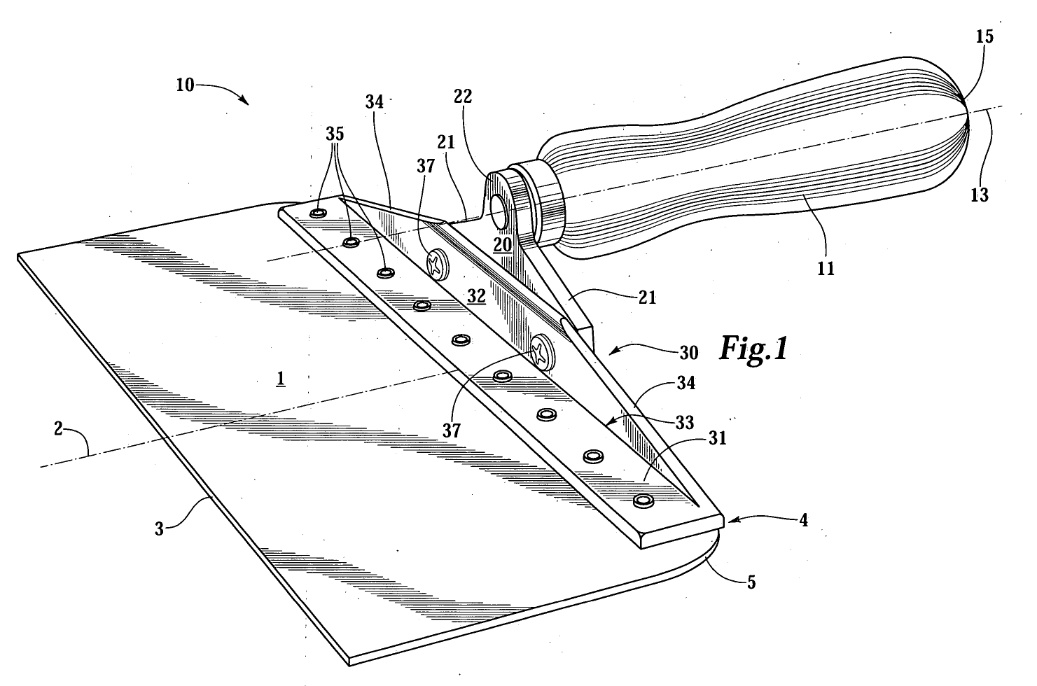

Turning now to the FIGS. 1-3, novel and improved finishing tool 10 includes substantially planar, generally rectangular stiff blade 1 with axis 2, straight front edge 3 substantially normal to axis 2, and rear 4 (FIG. 5). Elongate handle 11 includes front 12 and axis 13. Adapter 20 is connected to front 12 of handle 11, wherein the adapter has sides 21 and at least a portion of each side tapers upwardly, bracket 30 having first and second legs 31, 32, wherein first leg 31 is generally parallel to blade 1 and connected to rear 4 of blade 1 and first leg 31 has rear 33, wherein second leg 32 extends upwardly from rear 33 of first leg 31 and second leg 32 has sides 34 and at least a portion of each side 34 tapers upwardly and second leg 32 is connected to adapter 20, wherein front 12 of handle 11 is attached to adapter 20 so that handle axis 13 is generally parallel to blade axis 2 and generally centered with respect to blade 1, wherein each side 21 of adapter 20 forms a generally continuous taper with respect to corresponding side 34 of second leg 32.

Blade

Blade 1 has a front edge 3, rear edge 6, rear portion 4, a length along front and rear edges 3, 6, and a length between front and rear edges 3, 6. Blade 1 is generally planar. The width and length of blade 1 may be varied depending on the specific application intended for the knife, e.g. a narrow blade may be required for initially applying joint tape while a wider blade is more suitable for finishing the joint. In regards to blade length, a longer blade allows more compound to be applied at once, but also may make the tool less wieldy and the blade too flexible, so blade length may be varied depending in part on blade width. Blade 1 is generally rectangular but rear corners 5 may be rounded or chamfered to improve both safety and ease of use. The width of blade 1 may be between about 5 and about 14 inches and preferably between about 6 inches and 12 inches. The width of blade 1 may be selected from a range of predetermined widths, e.g. about 5 inches, about 6 inches, about 8 inches, about 10 inches, about 12 inches or about 14 inches, or such other widths and intervals as may be desired for particular applications and uses. Furthermore, the length of blade 1 is between about 1½ inches and about 5 inches, preferably between about 2 inches and about 4 inches, and still more preferably about 2½ inches. In one embodiment, rear corners 5 are rounded with radius of curvature between about ½ inch and about 1½ inches and preferably about 1 inch.

Blade 1 may be manufactured from such material with sufficient thickness and rigidity so that blade 1 is slightly flexible but will not substantially distort during normal use, e.g., in finishing drywall joints by applying drywall joint compound. Materials include but are not limited to metal and metal alloys, such as steel and steel alloys or aluminum and aluminum alloys, and rigid plastics. In one embodiment, blade 1 is made from spring steel with a thickness between about 0.01 inch and 0.025 inch, preferably between about 0.013 inch and about 0.02 inch, and still more preferably about 0.016 inch or about gage 26.

Bracket

Now referring to FIGS. 3 and 4, bracket 30 securely holds blade 1 and adapts it to handle 11. Bracket 30 may be generally L-shaped with first leg 31 and second leg 32. First leg 31 has a length which may vary depending on the length of blade 1, and first leg 31 may be generally planar. The ratio of the length of first leg 31 to the length of blade 1 may be increased for longer or thinner blades in order to reduce the flexibility of blade 1. First leg 31 also has a width which may be dependent on the width of blade 1, blade material, or blade thickness. First leg 31 of bracket 30 may be connected to rear 4 of blade 1 and generally centered with respect to the width of blade 1. First leg 31 may be connected to blade 1 using a variety of secure and generally permanent fastener such as rivets, screws, welds, and adhesives, and preferably a generally more permanent fastener such as welds or rivets. In one embodiment, blade 1 is connected to first leg 31 using rivets 35 which are secure, generally permanent, inexpensive, easily automated for manufacturing, and easily ascertainable. In one embodiment, the length of first leg 31 is between about 10% and about 40% of the length of blade 1, preferably between about 20% and about 30%, and still more preferably about 30%. In one embodiment, the length of first leg 31 is between about ½ inch and about 2 inches, preferably between about ⅝ inch and 1¼ inches, and still more preferably about ¾ inch. Furthermore, the width across axis 2 of first leg 31 is between about 60% and about 100% of the width of blade 1, preferably between about 80% and about 95%, and still more preferably about 90%. In one embodiment, the width of first leg 31 is between about 6 inches and about 12 inches, preferably between about 8 inches and about 11 inches, and still more preferably about 9 inches. In one embodiment, first leg 31 is connected to blade 1 so that rear 33 of first leg 31 is substantially flush with rear edge 6 of blade 1 and generally centered with respect to the width of blade 1.

Now referring to FIGS. 1, 3, and 4, second leg 32 of bracket 30 may extend upwards from first leg 31. Second leg 32 may be generally planar and form an angle with respect to first leg 31, or it may be curved. Second leg 32 may be generally trapezoidal wherein a lower portion has a width, an upper portion has a width substantially smaller than the width of the lower portion, and second leg 32 has a height. Sides 34 of second leg taper upwards and may form a generally smooth curve or a generally straight line. Second leg 32 may have holes 36 (FIG. 3) for mounting adapter 20 or may be directly connected to handle 11. In one embodiment, second leg 32 is generally straight and forms an angle with first leg 31 between about 45 and about 130 degrees, preferably, between about 70 and about 100 degrees, and still more preferably substantially normal. In one embodiment, second leg 32 is generally trapezoidal and the lower width is substantially equal to the width of first leg 31; the upper width of second leg 32 is between about 1 inch and about 6 inches, preferably between about 2 and 4 inches, and still more preferably about 3 inches; and the height of second leg 32 is between about ½ inch and about 4 inches, preferably between about 1 inch and about 2 inches, and still more preferably about 1 1/2 inches. In one embodiment, sides 34 of second leg 32 taper along a generally smooth line toward a midpoint of the width of the second leg 32.

Bracket 30 and its parts, supra, may be made from a substantially rigid material or combination of materials such as metals, woods, or plastics. The dimensions of blade 1 and its composition will in part determine the necessary thickness of bracket 30 so that bracket 30 will not easily distort during normal use and may securely hold blade 1. In one embodiment, bracket 30 is made from machined aluminum with a thickness between about 1/16 inch and about ¼ inch, preferably between about ⅛ and about ¼ inch, and still more preferably about ⅜ inch, because of this material's lightness, durability, strength, and clean appearance.

Adapter

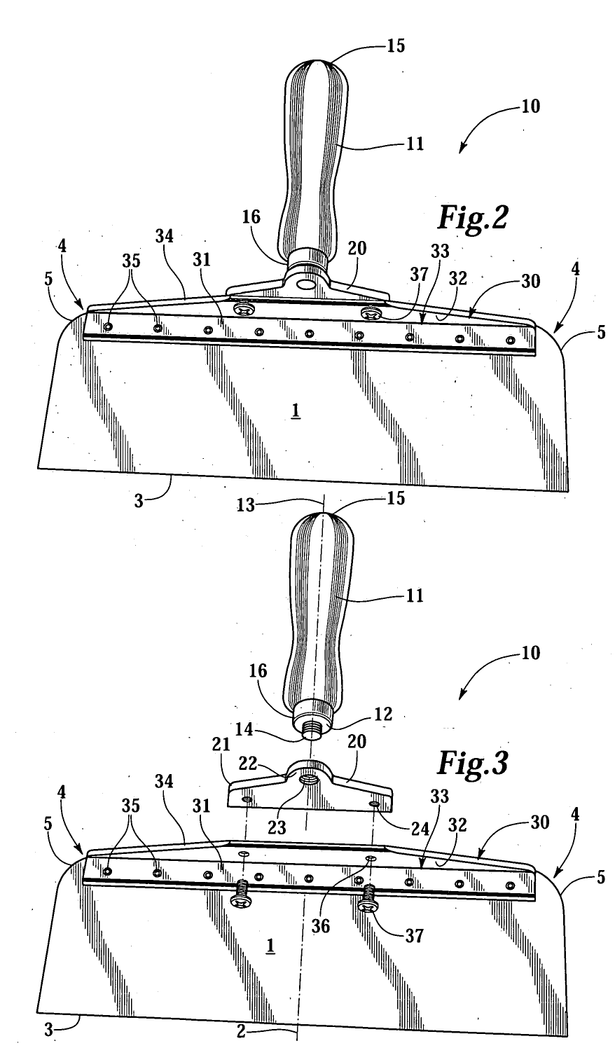

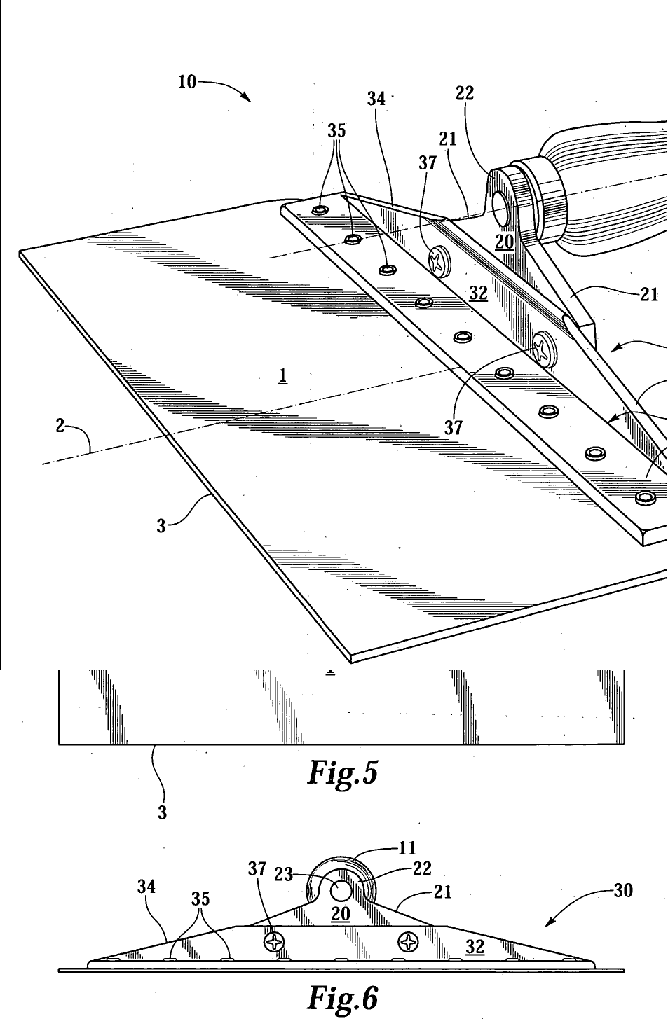

Continuing with FIGS. 2 and 3, handle 11 may connect directly to second leg 32 or through adapter or adapter plate 20 which has handle connecting area 22. While directly connecting handle 11 to second leg 32 may require less materials and may be less expensive to manufacture, the addition of adapter 20 allows greater flexibility in tool design. A few advantages are that the height of adapter 20 may be changed to increase or decrease the height of handle 11 above blade 1, adapter 20 may be bent or curved to impart an angle between handle 11 and blade 1, or handle connecting area 22 of adapter 20 may be moved laterally or angled laterally to improve tool usability for certain applications such as corner taping. Adapter 20 may be generally trapezoidal with a lower width, an upper width substantially smaller than the lower width, and a height. Furthermore, adapter 20 may have a protrusion which extends generally upwardly and forms handle connecting area 22. Sides 21 of adapter 20 may be tapered to allow the user to rest his or her finger or fingers comfortably while using tool 11. In one embodiment, adapter 20 is generally planar and trapezoidal with the lower width between about 1 inch and about 5 inches, preferably between about 2 inches and about 4 inches, and still more preferably about 3 inches; the upper width between about ½ inch and about 2 inches, preferably between about ⅝ inch and about 1 1 inches, and still more preferably about 1 inch; and the height between about ¾ inch and about 3 inches, preferably between about 1 inch and about 2 inches, and still more preferably about 1 inch. In one embodiment, handle connection area 22 extends upwardly from adapter 20 and forms a semi-circle with a radius between about ½ inch and about 1½ inches and preferable about 1 inch. Furthermore, sides 21 of adapter 20 are tapered so that, as viewed from the rear (FIG. 4), a generally continuous and generally straight line is formed between sides 34 of second leg 32 and sides 21 of adapter 20. In one embodiment, threaded hole 23 is tapped generally in the center of handle connecting area 22 for connecting handle 11 (see FIGS. 3 and 4), and a plurality of holes 24 are taped in the lower area of adapter 20 and register with holes 36 in second leg 32. The connection to bracket 30 may be made using a variety of means including machine screws, rivets, and welds. In one embodiment, a plurality of machine screws 37 are used, preferably between 2 and 4 screws and still more preferably 2 screws.

Adapter 20 may be constructed from such material and thickness that it is sufficiently rigid to deter bending during normal use of tool 10. Materials include but are not limited to metals, woods, and plastics. In one embodiment, adapter 20 is made from machined aluminum having a thickness between about 1/16 inch and about ¼ inch, preferably between about ⅛ and about ¼ inch, still more preferably about ⅜ inch, because of this material's lightness, durability, strength, relatively low cost, and clean appearance.

Handle

Now turning to FIGS. 1-3, handle 11 may be connected to adapter 20 or to bracket 30, e.g. to second leg 32, using any substantially secure fastener that will generally prevent rotation during normal use, for example threaded rods, bolts, screws, nails, adhesives, or welds. Handle 11 alternatively may be directed molded or machined into adapter 20 or second leg 32 if using moldable or machinable materials such as metals and plastics. In one embodiment, handle 11 is attached to adapter 20 using threaded rod 14, with a diameter between about ⅛ inch and ½ inch and preferably about ¼ inch, which extends between about ¼ inch and about 1 inch and preferably about ⅜ inch from handle front 12 and is received by tapped hole 23 through handle connecting area 22 of bracket 20. In one embodiment, handle 11 is connected so that handle axis 13 is generally centered and above blade axis 2 and generally parallel to blade axis 2. The height of handle 11 above blade 1 may be between about 1 inch and about 3 inches, preferably between about 1½ inches and about 2½ inches, still more preferably about 2 inches.

Handle 11 is an elongated handle which may be shaped to allow the user a comfortable grip. The shape of handle 11 may be of an ergonomic design and may include ridges, surface texturing, or other devices to enhance user grip. Handle 11 may be generally cylindrical with varying radii along its length, e.g. the middle of handle 11 may have a different radius from the front and rear of handle 11, and the middle radius may be substantially smaller than the front or rear radii. Handle rear 15 may be rounded for user comfort, flat, or may be tapped to allow the use of extension rods to enable use in out-of-reach areas. In one embodiment, the front radius of handle 11 is between about 1 inch and about 2 inches, preferably between about 1¼ inches and about 1¾ inches, and still more preferably about 1½ inches. Furthermore, the rear radius of handle 11 is about equal to the front radius of handle 11. In one embodiment, the middle radius of handle 11 is less than either the front radius or the rear radius of handle 11 and is between about ½ inch and about 1½ inches, preferably between about ¾ inch and about 1¼ inches, and still more preferably about 1 inch.

The material of handle 11 may be of such material that handle 11 is reasonable durable, light, and easy to grip. Possible materials include but are not limited to metals, woods, and plastics. Furthermore, handle 11 may have support band 16 which imparts additional strength at front 12 of handle 11. In one embodiment, handle 11 is made from wood which is durable, light, inexpensive, and easy to grip even when wet. Furthermore, support band 16 has length between about ¼ inch and about 1 inch and preferably about ½ inch.

While the foregoing written description of the invention enables one of ordinary skill to make and use what is considered presently to be the best mode thereof, those of ordinary skill will understand and appreciate the existence of variations, combinations, and equivalents of the specific exemplary embodiments and methods herein. The invention should therefore not be limited by the above described embodiments and methods, but by all embodiments and methods within the scope and spirit of the invention as claimed.

1. A finishing tool, comprising:
a substantially planar, generally rectangular stiff blade having a blade axis, a straight front edge substantially normal to said axis, and a rear;
an elongate handle having a front and a handle axis;
an adapter connected to said front of said handle, wherein said adapter has sides and at least a portion of each side tapers upwardly and inwardly toward said handle axis;
a bracket having first and second legs;
wherein said first leg is generally parallel to said blade and connected to said rear of said blade and said first leg has a rear;
wherein said second leg extends upwardly from said rear of said first leg and said second leg has two sides and at least a portion of each side tapers upwardly and inwardly toward said handle axis, and said second leg is connected to said adapter;
wherein said front of said handle is attached to said adapter so that said handle axis is generally parallel to said blade axis and generally centered with respect to said blade;
wherein said portion of each side of said adapter which tapers is substantially continuous with said portion of each corresponding side of said second leg which tapers.

2. A finishing tool according to claim 1, wherein said generally continuous taper is a generally straight line.

3. A finishing tool according to claim 1, wherein said first leg is connected to said rear of said blade by a plurality of rivets.

4. (canceled)

5. A finishing tool according to claim 1, wherein the width of said blade is selected from a range of predetermined widths, including about 5 inches, about 6 inches, about 8 inches, about 10 inches, about 12 inches and about 14 inches; the length of said blade is between about 2 inches and about 4 inches, and said rear of said blade has corners which are rounded with radius of curvature between about ½ inch and about 1½ inches.

6. A finishing tool according to claim 1, wherein said blade is made from spring steel with a thickness between about 0.013 inch and about 0.02 inch.

7. A finishing tool according to claim 1, wherein said first leg is connected to said blade using rivets.

8. A finishing tool according to claim 1, wherein the length of said first leg is between about 20% and about 30% of the length of blade, and the width of said first leg is between about 80% and about 95% of the width of blade

9. A finishing tool according to claim 1, wherein said bracket is made from machined aluminum with a thickness between about ⅛ inch and about ¼ inch.

10. A finishing tool according to claim 1, wherein said adapter is generally planar and trapezoidal with a lower width between about 2 inches and about 4 inches, an upper width between about ⅝ inch and about 1½ inches, and a height between about 1 inch and about 2 inches.

11. A finishing tool according to claim 1, wherein said handle is attached to said adapter using a threaded rod with a diameter between about ⅛ inch and about ½ inch and which extends between about ¼ inch and about 1 inch from said handle and is received by a tapped hole in said bracket.

12. A finishing tool according to claim 1, wherein said handle is connected so that said handle axis is generally centered and above said blade axis and generally parallel to said blade axis, and the height of said handle above said blade is between about 1½ inches and about 2½ inches.

13. A finishing tool according to claim 1, wherein said second leg forms an angle with said first leg between about 70 degrees and about 100 degrees.

14. A finishing tool according to claim 1, wherein said adapter is made from machined aluminum having a thickness between about ⅛ and about ¼ inch.
